(19) United States
(12) Patent Application Publication
(10) Pub. No.: US 2018/0349912 A1
(43) Pub. Date: Dec. 6, 2018

(54) Authenticating and authorizing retail transactions using face and location data

(71) Applicant: Eric M. Fiterman, Marina Del Ray, CA (US)

(72) Inventor: Eric M. Fiterman, Marina Del Ray, CA (US)

(21) Appl. No.: 16/001,081

(22) Filed: Jun. 6, 2018

Related U.S. Application Data
(60) Provisional application No. 62/515,630, filed on Jun. 6, 2017.

(51) Int. Cl. G06Q 20/40; G06Q 20/32; G06Q 20/36

(52) U.S. Cl. CPC G06Q 20/40145; G06Q 20/3224; G06Q 20/3674; G06Q 20/3221; G06Q 20/3226

(57) ABSTRACT

System and devices for using facial recognition for the authorization of commercial transactions in which facial image data and financial data is saved in a customer mobile device and transmitted to and registered with a backend processor; merchant locations are also registered with the backend processor. The customer mobile device sends a request to the back end processor for the initiation of a transaction with a merchant; the backend processor sends the request to the merchant, together with customer image and financial data. The merchant confirms the identity of the customer based on image comparison and authorizes the transaction on the merchant device which authorization is transmitted to the backend processor. The backend processor completes the transaction with the customer's financial institution.

### BACKGROUND OF THE INVENTION

The invention comprises a system to enable more convenient and secure in-person retail transactions.

In a typical in-person retail transaction, a merchant completes a sales transaction by entering customer payment data into a merchant Point-of-Sale (POS) system. The customer payment data may be a credit or debit card, or the like, with account data printed/embossed on its surface or encoded onto a magnetic stripe or EMV chip. If the POS system supports contactless payments, such as Near Field Communications (NFC), a customer may elect to use their mobile device to transmit payment data using a wireless communications protocol at the POS terminal. If the customer's financial institution authorizes the transaction, the merchant completes the sale and provides a receipt to the customer. The customer is confined to the merchant location during the entirety of this process because the customer must present physical property containing payment and/or identity data to the merchant or interact closely with the merchant POS device.

This payment approach reduces transaction convenience and increases the risk of fraud because the transaction can be completed by anyone in possession of the payment data.

### SUMMARY OF THE INVENTION

One object of the present invention is to provide a system by which merchants and customers may conduct in-person retail transactions without requiring a customer to present physical media (e.g., credit/debit card or mobile device) containing payment data, provide identity documentation (e.g. a driver's license) for security purposes, or interact with a merchant POS.

According to another aspect of the present invention, the system uses customer face image data to allow a merchant to verify the authenticity and accuracy of a transaction by matching face image data displayed on a merchant device to the actual facial appearance of the customer with whom they are conducting the transaction. Using this system, a customer can receive goods and services, in-person, in a frictionless, secure manner.

According to another aspect of the present invention, face image data is uploaded to the system by the customer/registered user together with payment/account data. The payment/account data is standard payment/account data specific to the customer/registered user, and the face image data may be a photograph, illustration, or likeness of the registered user. This may include digital photographs, processed images, rendered caricatures, or cartoons based on an image of the user.

According to another aspect of the present invention, a payment token is a unique payment method identifier that can be shared before, during, or after a transaction with a merchant to uniquely identify a customer payment method. The payment token is substituted for original account data in order to protect the confidentiality of payment information. Payment tokens may be internally generated or provisioned by third parties, for example, a digital wallet provider.

According to another aspect of the present invention, authorization data includes payment tokens, face image data, transaction data, and other metadata for registered customers.

According to another aspect of the present invention, a transaction is defined as the movement of funds between a merchant and customer account. A transaction may be facilitated using a credit card, debit card, cryptocurrency, blockchain technology, bank-to-bank transfer, automated clearing house (ACH), electronic funds transfer (EFT), intra-service account transfer, eChecks, or other kinds of financial transfer systems and payment instruments.

According to another aspect of the present invention, the system supports transactions that are submitted through an on-premises POS as well as transactions that are submitted through a payment processor outside of the merchant environment.

According to another aspect of the present invention, the system uses automated location services to establish customer presence and reduce the risk of loss due to fraudulent activity (e.g. in lieu of prompting for a 5-digit zip code).

According to another aspect of the present invention, a communications interface is an interface that enables electronic communication over wired or wireless data communications networks.

According to another aspect of the present invention, the transaction database is a database containing payment tokens, face image data, facial recognition data, location data, credit data, social media data, customer transaction history, customer behavior data, customer demographics, transaction details, customer identity information, merchant data, merchant location data, payment details and accounts, and other metadata regarding payment activity.

According to another aspect of the present invention, the facial recognition application is software/code on computer-readable media on one or more computer hardware devices that takes an input image, a set of search parameters, and outputs a set of customers from the customer database that fit the parameters of the search query.

According to another aspect of the present invention, the risk analytics application is software/code on computer-readable media on one or more computer hardware devices that assigns a composite risk score to a pending transaction.

According to another aspect of the present invention, the payment processing application is software/code on computer-readable media on one or more computer hardware devices that approves/declines transactions and facilitates the transfer of funds, currency, or credit between the merchant and customer using stored payment details.

According to another aspect of the present invention, the back end transaction processor is software/code that manages transactions throughout their lifecycle. The back end transaction processor may be composed of software on computer-readable media on one or more computer hardware devices or Software-as-a-Service (SaaS) components that reside on remote physical computers, devices, clouds, or infrastructure.

According to another aspect of the present invention, the location manager application is software/code on computer-readable media on one or more computer hardware devices that delivers notifications to the back end when a customer registered with a payment service is present at a merchant location.

According to another aspect of the present invention, the customer mobile device is a device that runs a payment application that delivers notifications to the back end when a registered user is present at a merchant location.

According to another aspect of the present invention, the location proxy application is optional software/code on computer-readable media on one or more computer hardware devices that delivers notifications to the back end. The location proxy may aggregate transactions for multiple customers and may be operated by a third-party. For example, the location proxy application could be operated by a social networking service, a food ordering service platform, a fuel-dispensing network, etc.

According to another aspect of the present invention, a location identifier is an identifier that may identify a specific table, kiosk, register, counter, fueling station, charging station, fuel pump, seat, booth, store, department, aisle, floor, lane, terminal, physical address, address components, GPS coordinates, Wi-Fi network, Bluetooth identifier, merchant name, or other identifier on the merchant's premises.

According to another aspect of the present invention, the sensor system is an optional system at a merchant location that may transmit or receive data from cameras, cellular radios, Wi-Fi radios, GPS sensors, IPS networks, Radio-frequency identification (RFID) sensors, Bluetooth sensors, or other kinds of sensor packages.

According to another aspect of the present invention, the token processor application is software/code on computer-readable media on one or more computer hardware devices used by the merchant to receive and transmit authorization data to/from the back end.

According to another aspect of the present invention, the token proxy system is hardware and software/code on computer-readable media to facilitate the entry or transmission of payment tokens into a POS system.

According to another aspect of the present invention, a virtual card is a computer-generated representation of authorization data received from the token processor that is displayed on a user interface.

According to another aspect of the present invention, a payment manager is a device used by the merchant to manage payments throughout their lifecycle.

According to another aspect of the present invention, the network is a data communications network that may be a private, public, wired, or wireless communications network. The customer mobile device, back end, payment manager, POS, and optional sensor system possess data communications interfaces that permit communication over the network.

### BRIEF DESCRIPTION OF FIGURES

FIG. 1 is a representation of the system invention.

### DETAILED DESCRIPTION OF THE INVENTION

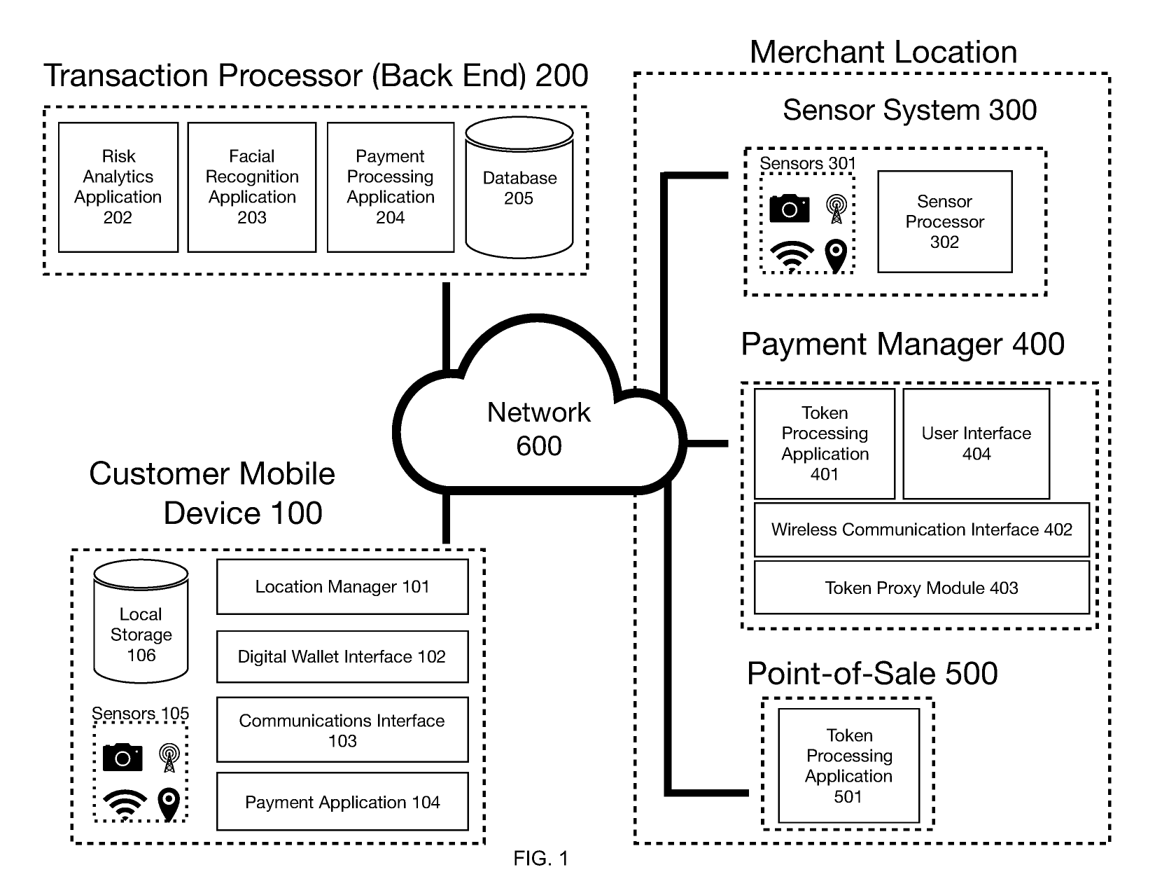

The present invention provides a system for conducting in-person retail transactions without requiring a customer to present physical media (e.g., credit/debit card or mobile device) containing payment data, provide identity documentation (e.g. a driver's license), or interact with a merchant POS. The primary components of a preferred embodiment of the present system are illustrated in FIG. 1.

The customer mobile device 100 contains a payment application 104 that allows the user to create transactions, review and edit transaction details, perform approvals, and manage transactions. The customer mobile device 100 may have a digital wallet interface 102 to create and store payment details and tokens in the transaction database 205.

The location manager application 101 determines the user's location. The location manager 101 may transmit and receive data from sensors 105, such as cameras, cellular radios, Wi-Fi radios, Global Positioning System (GPS) sensors, Indoor Positioning System (IPS) sensors, Radio-frequency identification (RFID) sensors, Bluetooth sensors, or other kinds of sensor packages. The sensors 105 may be located onboard the customer's mobile device 100 or may be external sensors that communicate with the location manager 101 using a data communications interface.

The location manager application 101 may be configured to recognize specific location identifiers detected using the sensors 105. Location identifiers may be saved in local storage 106 to assist with location determination or make more accurate estimations of a user's position, specifically in indoor or urban environments where GPS-based location determination is more difficult.

The customer mobile device 100 delivers notifications to the back end 200 when the location manager application 101 determines that the user is present in a merchant location. The customer mobile device 100 may be configured to deliver user notifications in an automated fashion or with user assistance.

The network 600 is a data communications network that may be a private, public, wired, or wireless communications network. The customer mobile device, back end, payment manager, POS, and optional sensor system possess data communications interfaces that permit communication over the network 600.

The sensor system 300 is an optional system located at a merchant location that assists in detecting the presence of registered users. The sensor system 300 incorporates sensors 301, which may include cameras, cellular radios, Wi-Fi radios, Global Positioning System (GPS) sensors, Indoor Positioning System (IPS) sensors, Radio-frequency identification (RFID) sensors, Bluetooth sensors, or other kinds of sensor packages.

The sensor system 300 is responsible for performing any of the following functions: 1) transmitting collected face image data to the back end 200 for user identification via the facial recognition application 203; 2) transmitting location identifiers received from sensors 301 to the location manager application 101; 3) receiving customer location data from the location manager application 101. The merchant sensor system 300 may be connected to the payment manager 400 by the network 600 or may be directly integrated into the software and hardware available in the payment manager 400.

The optional sensor processor 302 manages the configuration of the sensors 301 and data received from the sensors 301. The sensor processor 302 delivers notifications to the back end 200. The sensor processor 302 includes software to locally cache customer images that are sent to the facial recognition application 203. The sensor processor 302 stores identifiable facial feature patterns and data returned from the facial recognition application 203 to perform local facial recognition processing on image data.

The back end 200 coordinates transaction messaging. When the location manager application 101 or sensor processor 302 identifies a customer at the merchant location, a notification message is sent to the back end 200 that a customer is present in the retail location.

The transaction database 205 is a database containing payment tokens, stored payment details, face image data, facial recognition data, location data, customer identity information, credit data, social media data, transaction data, merchant data and other data used to manage transactions throughout their lifecycle.

The back end 200 may assign a composite risk score to the pending transaction using the risk analytics application 202. The risk analytics application 202 evaluates a transaction based on a variety of data inputs, including, but not limited to, facial recognition data, location data, credit data, social media data, customer transaction history, customer behavior, customer demographics, transaction details, date/time, and other metadata.

The payment processing application 204 is responsible for approving/declining transactions and facilitating the transfer of funds, currency, or credit between the merchant and customer using stored payment details. The payment processing application 204 may perform an optional pre-authorization using a customer's stored payment details.

The payment manager device 400 includes a user interface 404 which displays to the merchant virtual cards received from the token processing application 401 and allows a human operator to review, authorize, and submit sales transactions via the user interface 404. The payment manager device 400 may also be used to submit sales receipts and data.

The payment manager device 400 may also contain special token proxy hardware and software 403 to facilitate the presentation or transmission of payment tokens into a Point-of-Sale (POS) system 500. The token proxy may transmit tokens to the POS using NFC technology, Magnetic Secure Transmission (MST) technology, or other types of wireless transmission protocols. The tokens may also be keyed in manually using a human operator from the user interface 404.

The token processing application 401 provides a secure channel to conduct a transaction using a unique payment token. The payment token is supplied with customer face image data that can be used to verify the accuracy and authenticity of the transaction. The token processing application 401 may be installed onto a payment manager device 400 or a merchant's Point-of-Sale (POS) system 500.

When a transaction is approved by the payment processing application 204, the back end 200 transmits a message to the token processing application 401 containing the face image data, payment token, and other transaction metadata. These data are synthesized into virtual card representation and displayed on the payment manager device user interface 404.

The merchant may annotate additional transaction data with the virtual card to associate the payment with identifiers used in other merchant IT or POS systems (e.g. a table number, a reservation identifier, a vehicle license plate, etc.). The payment manager device 400 may be used to submit sales data to the back end 200 using the token processing application 401.

The token processing application 401 transmits sales data and token information to the back end 200. The back end 200 submits transaction data to the payment processing application 204 to complete the transaction. The payment processing application 204 queries the transaction database 205 to lookup the appropriate customer and merchant payment accounts that should be used to complete the transaction. The payment processing application 204 completes the transaction and updates the transaction database 205.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLE 1

A registered customer arrives at a retail service location and the payment application 104 on the registered user's mobile device 100 discovers a merchant's registered Bluetooth beacon at the merchant's physical location transmitted from a payment manager device 400 via the location manager application 101 and sensors 105. The payment application 104 on the customer mobile device 100 transmits a notification to the back end 200 notifying the back end 200 that the customer is present in the retail location. The payment processing application 204 determines that the transaction may proceed and queries the transaction database 205 to retrieve face image data, a payment token, and other transaction metadata. The back end 200 transmits a message to the payment manager device 400 containing the face image data, payment token, and other transaction metadata. These data are synthesized into a virtual card and displayed on the payment manager device user interface 404.

The merchant identifies a new virtual card displayed on the payment manager device 400 and recognizes the face presented on the user interface 404 as the customer that is present and receiving services. The merchant may optionally annotate additional transaction data with the virtual card to associate the payment with identifiers used in other merchant IT or POS systems (e.g. a table number, a reservation identifier, a vehicle license plate, etc.). The customer leaves after receiving services. The merchant then selects the customer's virtual card on the payment manager 400 and selects the function to submit the sales data.

The token processing application 401 transmits the sales data and token information to the back end 200. The back end 200 submits transaction data to the payment processing application 204 to complete the transaction. The payment processing application 204 queries the transaction database 205 to lookup the appropriate customer and merchant payment accounts that should be used to complete the transaction. The payment processing application 204 uses the stored payment details to complete the financial transaction.

### EXAMPLE 2

A customer arrives at a drive-through food service location that transmits a unique location identifier over Wi-Fi sensors 301 on a sensor system 300. The payment application 104 on the customer mobile device 100 receives the identifier and transmits a notification to the back end 200 notifying the back end 200 that a customer is present in the retail location. The payment processing application 204 determines that the transaction may proceed, queries the transaction database 205 to retrieve face image data, a payment token, and other transaction metadata corresponding to the customer/registered user. The back end 200 transmits a message to the payment manager device 400 containing the face image data, payment token, and other transaction metadata. These data are synthesized into a virtual card and displayed on the payment manager device user interface 404.

The customer pulls forward in their vehicle to receive their order. The merchant employee recognizes the customer from the virtual card that is displayed on the payment manager device 400. The merchant then selects the customer's virtual card on the payment manager user interface 404 and selects the function to transmit the payment token to the POS using the MST transmission interface of the token proxy module 403. The POS authorizes the transaction using the transmitted token. The customer leaves after receiving their order. The merchant then selects the customer's virtual card on the payment manager user interface 404 and selects the function to input the sales data.

The token processing application 401 transmits the input sales data to the back end 200. The back end 200 submits transaction data to the payment processing application 204 to complete the transaction. The payment processing application 204 queries the transaction database 205, determines the total balance has already been paid via the transmitted token, and marks the transaction as completed in the transaction database 205.

### EXAMPLE 3

A customer arrives at a re-fueling location in a vehicle. A camera sensor 301 on a sensor system 300 at the merchant location captures an image of a customer's face. The sensor processor 302 transmits a notification to the back end 200 that a customer is present in the retail location. The back end 200 queries the facial recognition application 203, which analyzes the face image data and determines that the image is of a registered user in the transaction database 205. As the total amount of the sale is not yet known, the payment processing application 204 conducts a preauthorization of the customer's stored payment method using a merchant-specific preauthorization amount. If successful, the payment processing application 204 queries the transaction database 205 to retrieve face image data, a payment token, and other transaction metadata.

The merchant uses a fuel pump Point-of-Sale device 500 that runs the token processing application 501. The token processing application 501 is configured to enable the fuel pump automatically upon receipt of a valid token. The back end 200 approves the transaction and transmits a message to the token processing application 501 containing the face image data, payment token, and other transaction metadata. The fuel pump is enabled on receipt of the token and the customer fuels their vehicle. After fueling is complete, the token processing application 501 transmits the sales data and token information to the back end 200. The back end 200 submits transaction data to the payment processing application 204 to complete the transaction. The payment processing application 204 queries the transaction database 205 to lookup the appropriate customer and merchant payment accounts that should be used to complete the transaction. The payment processing application 204 then completes the transaction using the total and the stored payment details from the transaction database 205.

### EXAMPLE 4

A customer arrives at a full-service restaurant. The customer mobile device 100 uses GPS sensors 105 to determine that the user is present in a retail location and prompts the user to transmit a notification message to the back end 200. The user approves the request and the customer mobile device 100 transmits a notification to the back end 200 that the customer is present in the retail location. The back end 200 assigns a composite risk score to the pending transaction using the risk analytics application 202, which has determined that the transaction can be authorized. The payment processing application 204 conducts a preauthorization of the customer's stored payment method, and if successful, queries the transaction database 205 to retrieve face image data, a payment token, and other transaction metadata. The back end 200 transmits a message to the payment manager device 400 containing the face image data, payment token, and other transaction metadata. These data are synthesized into a virtual card and displayed on the payment manager device user interface 404.

The merchant identifies a new virtual card on the payment manager device 400 and recognizes the face presented on the screen as the customer that is present and receiving services. The merchant may optionally annotate additional transaction data on the payment manager to associate the virtual card with identifiers used in other merchant IT or POS systems (e.g. a table number, a reservation identifier, etc.). The customer then leaves the merchant location. The merchant then selects the customer's virtual card on the payment manager user interface 404 and selects the function to submit the sales data to the back end.

The token processing application 401 transmits the input sales data and token information to the back end 200. The back end 200 submits transaction data to the payment processing application 204 to complete the transaction. The payment processing application 204 queries the transaction database 205 to lookup the appropriate customer and merchant payment accounts that should be used to complete the transaction. The payment processing application 204 then completes the transaction using the total and the stored payment details from the transaction database 205.

### EXAMPLE 5

A customer creates a new transaction on the payment application 104 on the customer mobile device 100 indicating that the customer wishes to order goods for pick up at a specific merchant location at a later date. The customer mobile device 100 transmits a notification to the back end 200 specifying transaction details. The payment processing application 204 processes the transaction using the total and the stored payment details from the transaction database 205.

The customer later enters the merchant location to pick up the ordered goods. The customer mobile device 100 discovers a registered Bluetooth beacon associated with the retail location via the on-board location manager application 101 and sensors 105. The payment application 104 on the customer mobile device 100 transmits a notification to the back end 200 notifying the back end 200 that the customer is present in the retail location. The back end queries the transaction database 205 and determines the payment has been successfully processed. The back end 200 transmits a message to the payment manager device 400 containing the face image data, payment token, and other transaction metadata. These data are synthesized into a virtual card and displayed on the payment manager device user interface 404.

A merchant employee recognizes the customer from the virtual card that is displayed on the payment manager device 400 and provides the goods to the customer. The customer leaves after receiving their order. The merchant then selects the customer's virtual card on the payment manager user interface 404 and selects the function to submit the sales data to the back end 200.

The token processing application 401 transmits the input sales data to the back end 200. The back end 200 submits transaction data to the payment processing application 204 to complete the transaction. The payment processing application 204 queries the transaction database 205, determines the total balance has already been paid, and marks the transaction as completed in the transaction database 205.

I claim:

1. A facial recognition sales transaction authorization system comprising:
a customer mobile device,
a merchant device, and
a backend-transaction processor device,
the customer mobile device comprising software code stored on a tangible computer-readable storage device containing instructions for causing the customer mobile device to;
i) receive and store customer-input image data corresponding to a customer's facial features;
ii) receive and store financial data sufficient to conduct a transaction;
iii) transmit registration data, including face image and financial data, to the back end transaction processor device;
iv) receive location data from sensors;
v) transmit notification messages to the back end transaction processor device to initiate a transaction with a merchant;
vi) receive transaction activity data from the back end transaction processor; and
vii) display, at customer request, transaction activity.
the backend-transaction processor device comprising software code stored on a tangible computer-readable storage device containing instructions for causing the backend transaction processor device to:
i) receive registration data, including face image and financial data, from the customer mobile device;
ii) receive notification messages from the customer mobile device to initiate a transaction with a merchant;
iii) transmit bundled payment token and customer face image data to a registered merchant device when a the backend transaction processor device receives a notification from a customer mobile device for the initiation of a transaction with a merchant;
iv) transmit data to financial institutions and affiliates in order to complete sales transactions between merchant and customer using stored financial data; and
v) transmit transaction activity data to the customer mobile device;
the merchant device comprising software code stored on a tangible computer-readable storage device containing instructions for causing the merchant device to:
i) authenticate the merchant account with the backend transaction processor device to receive notifications when a customer wishes to conduct a transaction with the merchant;
ii) receive bundled face image data and payment token information transmitted from the back end transaction processor device corresponding to a specific customer who is, was, or will be present at the merchant location based on notification from a customer mobile device for the initiation of a transaction with a merchant;
iii) optionally display face image data for identification of a customer by the merchant;
iv) optionally display payment token information, and transaction data for a transaction matched to an identified customer;
v) receive input concerning initial, edited and amended sales transaction data for a specific customer transaction; and
vi) transmit sales transaction data to the back end transaction processor device.

2. A facial recognition sales transaction authorization system according to claim 1, wherein the customer-input image data corresponding to a customer's facial features is image data received from a camera device on the customer mobile device.

3. A facial recognition sales transaction authorization system according to claim 1, wherein the financial data sufficient to conduct a transaction comprises one or more of the following: credit card information and bank account information.

4. A facial recognition sales transaction authorization system according to claim 1, wherein the transaction activity data is selected from one or more of the following: sales receipts, receipt images, itemized sales data, sales total, credits, tax, gratuity, date and time information, merchant name, address, contact information, staff/employee names, and other transaction metadata.

5. A facial recognition sales transaction authorization system according to claim 1, wherein the merchant sensor system transmits and receives data from sensors to detect the presence of registered users in a merchant location.

6. A facial recognition sales transaction authorization system according to claim 1, wherein the customer mobile device receives and transmits data from/to sensors to detect the presence of registered merchant sensor systems.

7. A facial recognition sales transaction authorization system according to claim 1, wherein the customer mobile device receives tokens from a digital wallet interface and transmits them to the back end transaction processor device.

8. A facial recognition sales transaction authorization system according to claim 1, wherein the merchant device further comprises token proxy hardware and/or software that transmits tokens to a merchant point of sale system.

9. A facial recognition sales transaction authorization system according to claim 1, wherein the back end transaction processor device receives face image data from merchant sensor systems and identifies registered customer matches and payment tokens.

10. A facial recognition sales transaction authorization system according to claim 1, wherein the back end transaction processor device transmits merchant location data to the customer mobile device.

11. A backend-transaction processor device comprising software code stored on a tangible computer-readable storage device containing instructions for causing the backend transaction processor device to:
i) receive registration data, including face image and financial data, from a customer mobile device;
ii) receive notification messages from the customer mobile device to initiate a transaction with a merchant;
iii) transmit bundled payment token and customer face image data to a registered merchant device when a the backend transaction processor device receives a notification from a customer mobile device for the initiation of a transaction with a merchant;
iv) transmit data to financial institutions and affiliates in order to complete sales transactions between merchant and customer using stored financial data; and
v) transmit transaction activity data to the customer mobile device.
